(19) United States
(12) Patent Application Publication
(10) Pub. No.: US 2012/0169159 A1
(43) Pub. Date: Jul. 5, 2012

(54) APPARATUS FOR VENTILATING STATOR CORE

(75) Inventor: Peter Anthony DiLorenzo, Charlton, NY (US)

(73) Assignee: GENERAL ELECTRIC COMPANY, Schenectady, NY (US)

(21) Appl. No.: 12/985,018

(22) Filed: Jan. 5, 2011

(51) Int. Cl. H02K 9/02

(52) U.S. Cl. 310/59

(57) ABSTRACT

An apparatus for venting a stator core having a plurality of slots through which stator windings extend is provided. The apparatus includes a first ventilation layer for positioning at an end of the stator core. The first ventilation layer includes an inner set of circumferentially spaced slots that correspond to the plurality of slots and through which the stator windings extend, and an outer set of slots radially distanced from the inner set of slots. A second ventilation layer for positioning between the first ventilation layer and a stator core flange of the stator core is also provided. The second ventilation layer includes a set of ventilation slots providing a flow path between the stator windings to the outer set of slots.

### BACKGROUND OF THE INVENTION

The disclosure relates generally to dynamoelectric machines, and more particularly, to an apparatus for ventilating a stator core and a related stator and dynamoelectric machine.

Dynamoelectric machines include a stator that typically requires cooling. One method of cooling uses convection of air across stator windings. In order to provide a radial path for air flow across stator windings, outside space blocks have been used with stator core flanges, which are end pieces of a stator core that are used to clamp stator core laminations together. A large number of outside space blocks are welded to the stator core flange to provide the flow path.

### BRIEF DESCRIPTION OF THE INVENTION

A first aspect of the disclosure provides a dynamoelectric machine comprising: a rotor; and a stator electromagnetically coupled to the rotor, the stator including: a plurality of stator core laminations, the plurality of stator core laminations including a plurality of slots through which stator windings extend; a first ventilation layer positioned adjacent to an end lamination of the plurality of stator core laminations, the first ventilation layer including: an inner set of slots corresponding to the plurality of slots of the stator core laminations and through which the stator windings extend, and an outer set of slots radially distanced from the inner set of slots; a second ventilation layer positioned adjacent to the first ventilation layer, the second ventilation layer including a set of slots providing a flow path between the stator windings to the outer set of slots; and a stator core flange positioned adjacent to the second ventilation layer.

A second aspect of the disclosure provides a stator for a dynamoelectric machine, the stator comprising: a stator core including a plurality of stator core laminations including a plurality of slots through which stator windings extend; a first ventilation layer positioned adjacent to an end lamination of the plurality of stator core laminations, the first ventilation layer including an outer set of slots about a peripheral edge thereof; a second ventilation layer positioned adjacent to the first ventilation layer, the second ventilation layer including a set of ventilation slots providing a flow path between the stator windings to the outer set of slots; and a stator core flange positioned adjacent to the second ventilation layer.

A third aspect of the disclosure provides an apparatus for ventilating a stator core having a plurality of slots through which stator windings extend, the apparatus comprising: a first ventilation layer for positioning at an end of the stator core, the first ventilation layer including: an inner set of circumferentially spaced slots that correspond to the plurality of slots and through which the stator windings extend, and an outer set of slots radially distanced from the inner set of slots; and a second ventilation layer for positioning between the first ventilation layer and a stator core flange of the stator core, the second ventilation layer including a set of ventilation slots providing a flow path between the stator windings to the outer set of slots.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a partial perspective view of an apparatus (without stator winding), a stator and a dynamoelectric machine according to embodiments of the invention.

FIG. 2 shows a perspective view of the apparatus of FIG. 1, without a rotor, according to embodiments of the invention.

FIG. 3 shows a perspective view of the apparatus with a first ventilation layer of the apparatus exposed.

FIG. 4 shows a perspective view of the apparatus with a second ventilation layer of the apparatus exposed.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

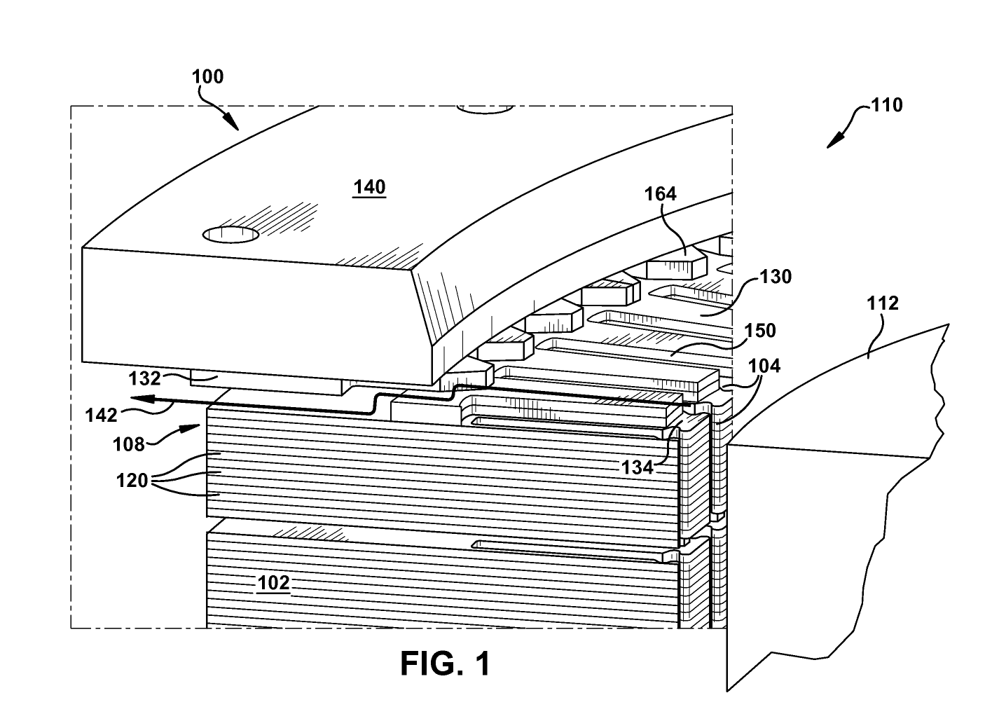

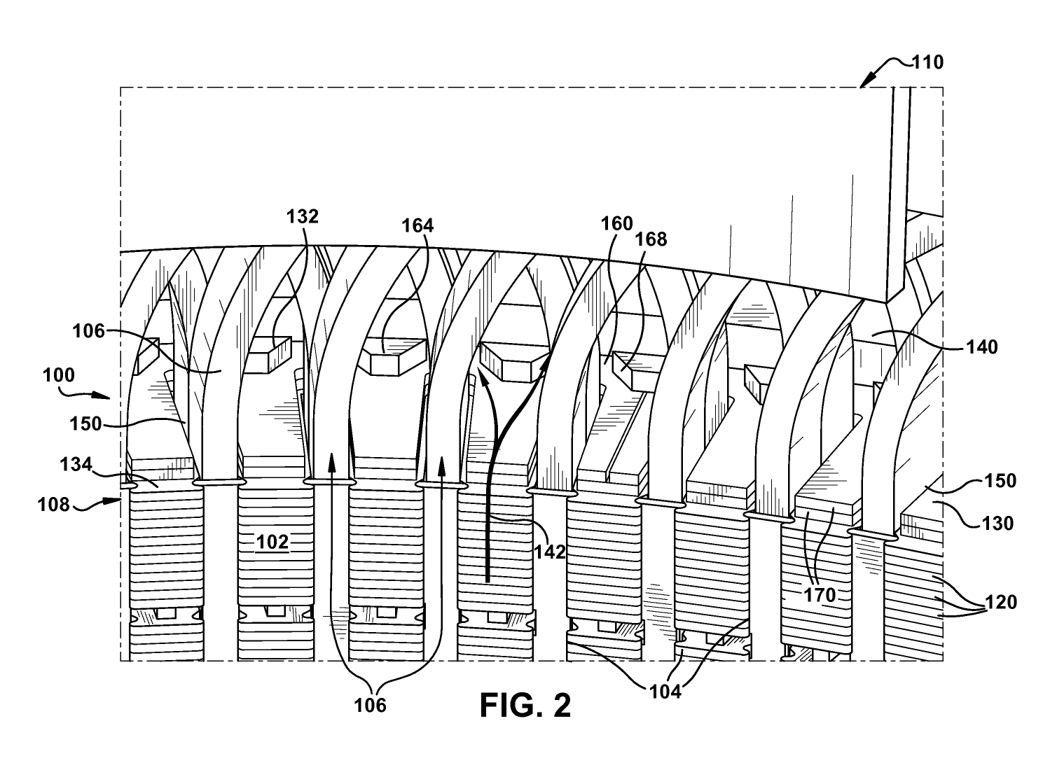

Referring to the drawings, and in particular FIGS. 1-2, embodiments of an apparatus 100 for ventilating a stator core 102 having a plurality of slots 104 through which stator windings 106 (FIG. 2) extend will be described. A stator 108, including stator core 102 among other structure, and a dynamoelectric machine 110 including the same are also provided. Referring to FIG. 1, a schematic of a dynamoelectric machine 110 using an apparatus 100 according to embodiments of the invention is illustrated. Dynamoelectric machine 110 includes a rotor 112 and stator 108 electromagnetically coupled to the rotor. Rotor 112 and stator 108 may constitute any form of dynamoelectric machine such as a generator, motor, etc. Rotor 112 may be a non-stationary component of dynamoelectric machine 100 and stator 108 may be a stationary component of machine 100. Stator 108 and rotor 112 may be electromagnetically coupled, and during operation, may be used, e.g., to generate electricity or power a load as is known in the art. Dynamoelectric machine 100 may operate as any conventional dynamoelectric machine. Stator 108 includes a plurality of stator core (magnetic) laminations 120, which are stacked together to form stator core 102. Plurality of stator core laminations 120 include plurality of slots 104 (FIG. 2) through which stator windings 106 (FIG. 2) extend.

Apparatus 100 includes a first ventilation layer 130 and a second ventilation layer 132. First ventilation layer 130 is positioned adjacent to an end lamination 134 of plurality of stator core laminations 120, and second ventilation layer 132 is positioned adjacent to first ventilation layer 130. A stator core flange 140 (FIGS. 1 and 2 only) is positioned adjacent to second ventilation layer 132 for coupling stator core laminations 120 together in a typical fashion. As will be described in greater detail herein, apparatus 100 provides a flow path 142 (FIGS. 1, 2 and 4) between stator windings 106 (FIG. 2 only) and also under stator core flange 140, as illustrated.

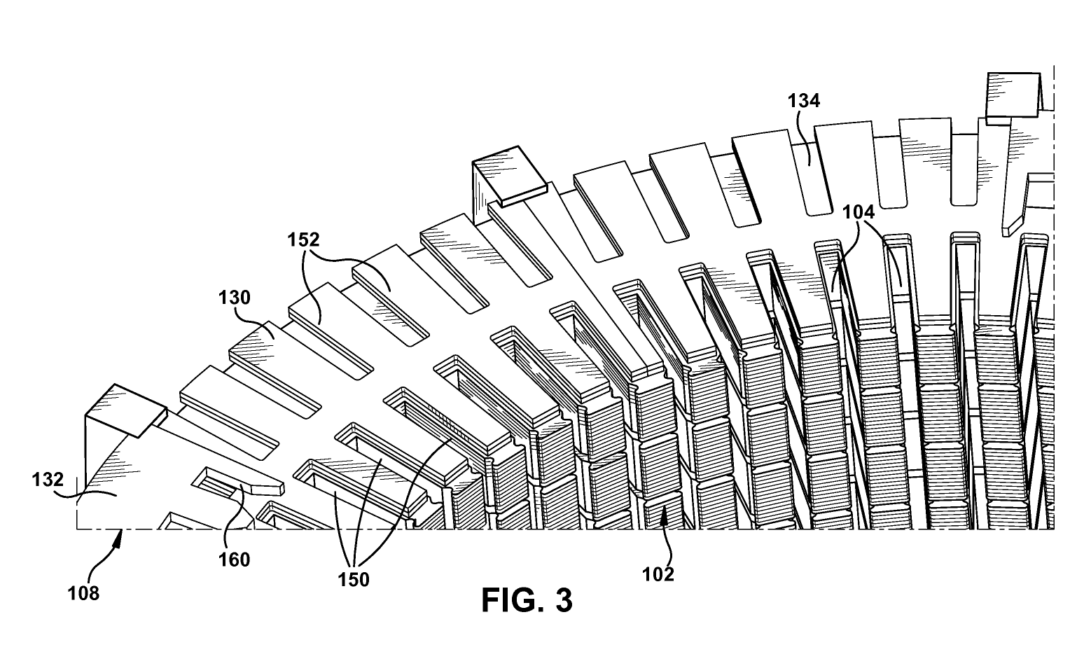

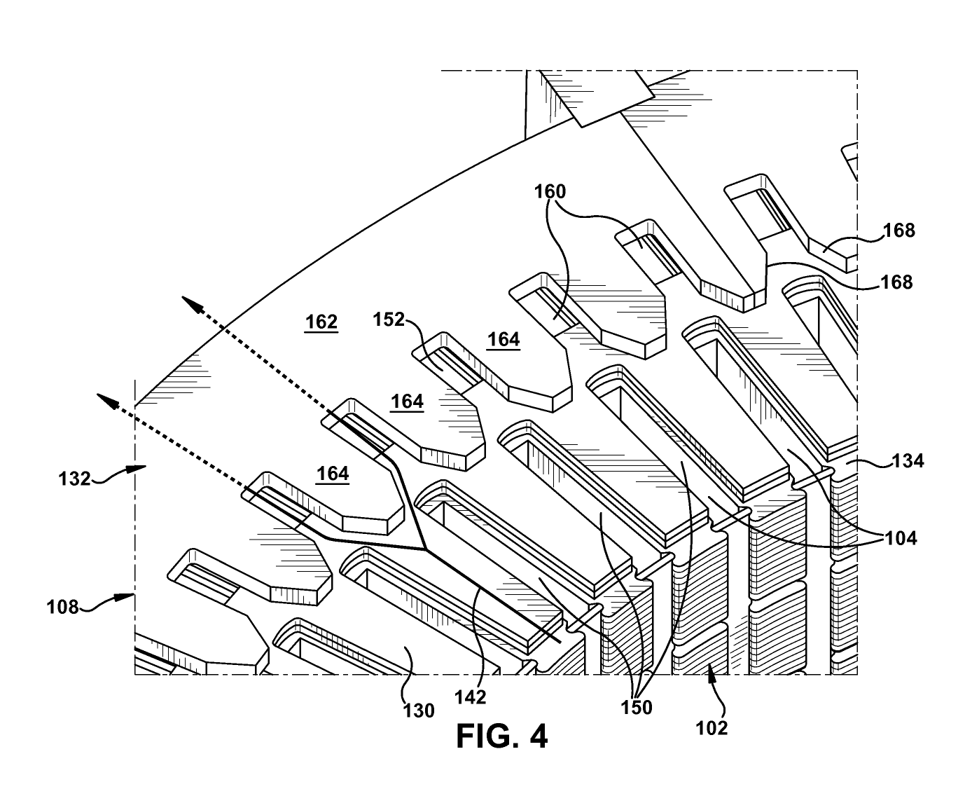

As shown best in FIGS. 2 and 3, first ventilation layer 130 includes an inner set of slots 150 corresponding to plurality of slots 104 of stator core laminations 120 and through which stator windings 106 (FIG. 2 only) extend. As shown in FIG. 3, first ventilation layer 130 also includes an outer set of slots 152 radially distanced from inner set of slots 150. “Inner” and “outer” as used herein indicate relative position of slots 150, 152 relative to rotor 112 (FIG. 1). As shown best in FIG. 4, second ventilation layer 132 includes a set of ventilation slots 160 providing a portion of flow path 142 between stator windings 106 to outer set of slots 152. More specifically, in one embodiment, second ventilation layer 132 may include an arcuate section 162 having a set of circumferentially spaced ventilation members 164 on a radially inward portion thereof. Arcuate sections 162 may be positioned adjacent to one another about stator core 102 to form an annular member. Adjacent ventilation members 164 include a ventilation slot 160 therebetween such that each slot 160 is radially aligned with a corresponding stator winding 106 (FIG. 2) and in fluid communication with an outer slot 152. Each ventilation member 164 is spaced from an adjacent stator winding 106 (FIG. 2) to provide flow path 142 between stator windings 106 to outer set of slots 152. Flow path 142 between stator windings 106 and ventilation members 164 is best observed in FIGS. 1 and 2 in how ventilation members 164 are distanced from a corner of slots 150 and 104, providing a space between the ventilation members 164 and stator windings 106 to outer slots 152. In one embodiment, each ventilation member 164 may include an angled end 168 adjacent each stator winding 106 (FIG. 2) to provide a portion of flow path 142, as described. However, other shapes on ventilation members 164 may be possible. Furthermore, it is understood that each layer 130, 132 may take another shape and still provide flow path 142 as described herein.

Each ventilation layer 130, 132 may include a plurality of laminations, e.g., laminations 170 as shown in FIG. 2 for first ventilation layer 130, of any suitable material capable of withstanding environmental conditions in the particular dynamoelectric machine 100, e.g., steel. However, a laminated structure for each ventilation layer is not necessary. Each layer 130, 132 may be formed as a single annular ring or, as shown in FIGS. 3 and 4, may be segmented into arcuate sections to allow for a simplified assembly of the stator core assembly. Layers 130, 132 can be formed using any now known or later developed techniques, e.g., punching or laser cutting from sheet material.

As described herein, apparatus 100 provides a flow path 142 for cooling stator windings 106, among other structures. Flow path 142 extends radially and partially axially relative to stator core laminations 120. More particularly, flow path 142 passes from between stator 108 and rotor 112 and passes radially outward between stator windings 106 (FIG. 2) and between stator windings 106 and ventilation members 164 into outer slots 152 of first ventilation layer 130. As best seen in FIGS. 1 and 4, as flow path 142 enters outer slots 152, it passes axially slightly towards end laminate 134 of stator core laminations 120. Flow path 142 then passes radially outward between second ventilation layer 132, edges of outer slots 152 of first ventilation layer 130 and end laminate 134. As flow path 142 passes through the stated parts, it also cools stator core flange 140 as it passes thereby. Consequently, apparatus 100 provides a low cost alternative to providing a flow path under a stator core flange by removing the need for a large number of outside space blocks. Each layer 130, 132 and slots 150, 152, 160 thereof can be sized and shaped to route flow path 142 as required for a particular dynamoelectric machine 100 and to control the amount of flow by stator core flange 140, i.e., the position and size of flow path 142 may vary from that described above. Apparatus 100 may also reduce stator 108 costs and may reduce the cycle time to build each stator. For example, there is no welding on stator core flange 140 with this arrangement, which may reduce the cycle time for the build of stator core 108.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A dynamoelectric machine comprising:
a rotor; and
a stator electromagnetically coupled to the rotor, the stator including:
a plurality of stator core laminations, the plurality of stator core laminations including a plurality of slots through which stator windings extend;
a first ventilation layer positioned adjacent to an end lamination of the plurality of stator core laminations, the first ventilation layer including:
an inner set of slots corresponding to the plurality of slots of the stator core laminations and through which the stator windings extend, and
an outer set of slots radially distanced from the inner set of slots;
a second ventilation layer positioned adjacent to the first ventilation layer, the second ventilation layer including a set of slots providing a flow path between the stator windings to the outer set of slots; and
a stator core flange positioned adjacent to the second ventilation layer.

2. The dynamoelectric machine of claim 1, wherein the first ventilation layer includes a plurality of laminations.

3. The dynamoelectric machine of claim 1, wherein the second ventilation layer includes a plurality of laminations.

4. The dynamoelectric machine of claim 1, wherein the second ventilation layer includes an arcuate section having a set of circumferentially spaced ventilation members on a radially inward portion thereof, wherein adjacent ventilation members include a ventilation slot therebetween that is radially aligned with a corresponding stator winding and in fluid communication with the set of outer slots.

5. The dynamoelectric machine of claim 4, wherein each ventilation member is spaced from an adjacent stator winding to provide the flow path between the stator windings to the outer set of slots.

6. The dynamoelectric machine of claim 5, wherein each ventilation member includes an angled end adjacent each stator winding.

7. The dynamoelectric machine of claim 1, wherein the flow path extends radially and partially axially relative to the plurality of stator core laminations.

8. A stator for a dynamoelectric machine, the stator comprising:
a stator core including a plurality of stator core laminations including a plurality of slots through which stator windings extend;
a first ventilation layer positioned adjacent to an end lamination of the plurality of stator core laminations, the first ventilation layer including an outer set of slots about a peripheral edge thereof;
a second ventilation layer positioned adjacent to the first ventilation layer, the second ventilation layer including a set of ventilation slots providing a flow path between the stator windings to the outer set of slots; and
a stator core flange positioned adjacent to the second ventilation layer.

9. The stator of claim 8, wherein the first ventilation layer and the second ventilation layer each include a plurality of laminations.

10. The stator of claim 8, wherein the second ventilation layer includes an arcuate section having a set of circumferentially spaced ventilation members on a radially inward portion thereof, wherein adjacent ventilation members include a ventilation slot therebetween that is radially aligned with a corresponding stator winding and in fluid communication with the set of outer slots.

11. The stator of claim 10, wherein each ventilation member is spaced from an adjacent stator winding to provide the flow path between the stator windings to the outer set of slots.

12. The stator of claim 11, wherein each ventilation member includes an angled end adjacent each stator winding.

13. The stator of claim 8, wherein the flow path extends radially and partially axially relative to the plurality of stator core laminations.

14. An apparatus for ventilating a stator core having a plurality of slots through which stator windings extend, the apparatus comprising:
a first ventilation layer for positioning at an end of the stator core, the first ventilation layer including:
an inner set of circumferentially spaced slots that correspond to the plurality of slots and through which the stator windings extend, and
an outer set of slots radially distanced from the inner set of slots; and
a second ventilation layer for positioning between the first ventilation layer and a stator core flange of the stator core, the second ventilation layer including a set of ventilation slots providing a flow path between the stator windings to the outer set of slots.

15. The apparatus of claim 14, wherein the first ventilation layer includes a plurality of laminations.

16. The apparatus of claim 14, wherein the second ventilation layer includes a plurality of laminations.

17. The apparatus of claim 14, wherein the second ventilation layer includes an arcuate section having a set of circumferentially spaced ventilation members on a radially inward portion thereof, wherein adjacent ventilation members include a ventilation slot therebetween that is radially aligned with a corresponding stator winding and in fluid communication with the set of outer slots.

18. The apparatus of claim 17, wherein each ventilation member is spaced from an adjacent stator winding to provide the flow path between the stator windings to the outer set of slots.

19. The apparatus of claim 18, wherein each ventilation member includes an angled end adjacent each stator winding.

20. The apparatus of claim 14, wherein the flow path extends radially and partially axially relative to the stator core.
